(19) United States
(12) Patent Application Publication
(10) Pub. No.: US 2009/0275400 A1
(43) Pub. Date: Nov. 5, 2009

(54) MULTIPLE DENOMINATION PROGRESSIVE JACKPOTS

(75) Inventors: David Rehm, Stanardsville, VA (US); Robert Crowder, Las Vegas, NV (US)

Correspondence Address: SEED INTELLECTUAL PROPERTY LAW GROUP, PLLC, 701 FIFTH AVENUE, SUITE 5400, SEATTLE, WA, 98104, US

(73) Assignee: BALLY GAMING, INC., Las Vegas, NV (US)

(21) Appl. No.: 12/112,770

(22) Filed: Apr. 30, 2008

(51) Int. Cl. A63F 9/24; A63F 13/00

(52) U.S. Cl. 463/27

(57) ABSTRACT

A gaming device operable to accept wagers in a plurality of bet denominations accepts a first wager associated with a first bet denomination and a second wager associated with a second, different bet denomination. The first wager is then logically associated with a first progressive jackpot, and the second wager is logically associated with a second progressive jackpot different than the first progressive jackpot.

### BACKGROUND

1. Technical Field

This description generally relates to the field of gaming devices, and more particularly to enabling participation in progressive jackpots associated with multiple denominations at a gaming device.

2. Description of the Related Art

Gaming properties often devote a large percentage of floor space to gaming devices. Each gaming device presents players with individual games of chance, games of skill, or combinations thereof that they may wager on.

In the past, each gaming device would present a player with only one such game, and the player would then choose from among the available gaming devices to find her preferred game. In order to provide even greater choices to modern gaming property patrons, many gaming devices now comprise general purpose computing devices, and each gaming device can thus offer an array of gaming choices to players. For example, a single gaming device may offer video poker, video blackjack and video slots. The gaming device may also accept wagers associated with a variety of bet denominations (e.g., $0.01, $0.05, $0.10, $0.25, $0.50, $1, and so on). Thus, a gaming device may be configured to offer a number of players the game they wish to play at their individually selected bet denomination. This flexibility better enables a gaming property to meet player demands. If every player in a modern gaming property desires to play $1 video slots, every gaming device in the gaming property may be capable of providing this option.

However, it would be desirable to make play of these flexible gaming devices even more enjoyable to the players.

### BRIEF SUMMARY

In one embodiment, a computer-implemented method of enabling participation in progressive jackpots in a gaming property comprises: accepting a first wager at a gaming device operable to accept wagers in a plurality of bet denominations, the first wager associated with a first bet denomination; logically associating the first wager with a first progressive jackpot; accepting a second wager at the gaming device, the second wager associated with a second bet denomination different than the first bet denomination; and logically associating the second wager with a second progressive jackpot different than the first progressive jackpot.

In another embodiment, a gaming device is disclosed, the gaming device comprising: a housing; a display carried by the housing; a user interface carried by the housing and configured to receive user input from a player; a processor that executes instructions; and a computer-readable memory that stores instructions. The instructions of the computer-readable memory may cause the processor to enable participation in progressive jackpots, by: accepting a first wager associated with a first bet denomination via the user interface; logically associating the first wager with a first progressive jackpot; accepting a second wager associated with a second bet denomination different than the first bet denomination via the user interface; and logically associating the second wager with a second progressive jackpot different than the first progressive jackpot.

In yet another embodiment, a computer-readable medium stores instructions that cause a processor to enable participation in progressive jackpots, by: receiving information indicative of a first wager made at a gaming device; determining a first bet denomination associated with the first wager; logically associating the first wager with a first progressive jackpot; receiving information indicative of a second wager made at the gaming device; determining a second bet denomination associated with the second wager, the second bet denomination different than the first bet denomination; and logically associating the second wager with a second progressive jackpot different than the first progressive jackpot.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a perspective view of a gaming device enabling participation in at least two progressive jackpots, according to one illustrated embodiment.

FIG. 2 is a schematic view of the gaming device of FIG. 1, according to one illustrated embodiment.

FIG. 3 is a high-level schematic view of a gaming property including a progressive jackpot controller coupled to a plurality of gaming devices as well as a global progressive jackpot display, according to one illustrated embodiment.

FIG. 4 is a schematic view of the progressive jackpot controller of FIG. 3, according to one illustrated embodiment.

FIG. 5 is a flow diagram illustrating a method for enabling participation in progressive jackpots, according to one illustrated embodiment.

FIG. 6 is a flow diagram illustrating a method for enabling participation in progressive jackpots, according to another illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures and methods associated with gaming properties, gaming devices, games of chance, progressive jackpots, controllers and network communications have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the embodiments.

### Description of an Exemplary Gaming Device

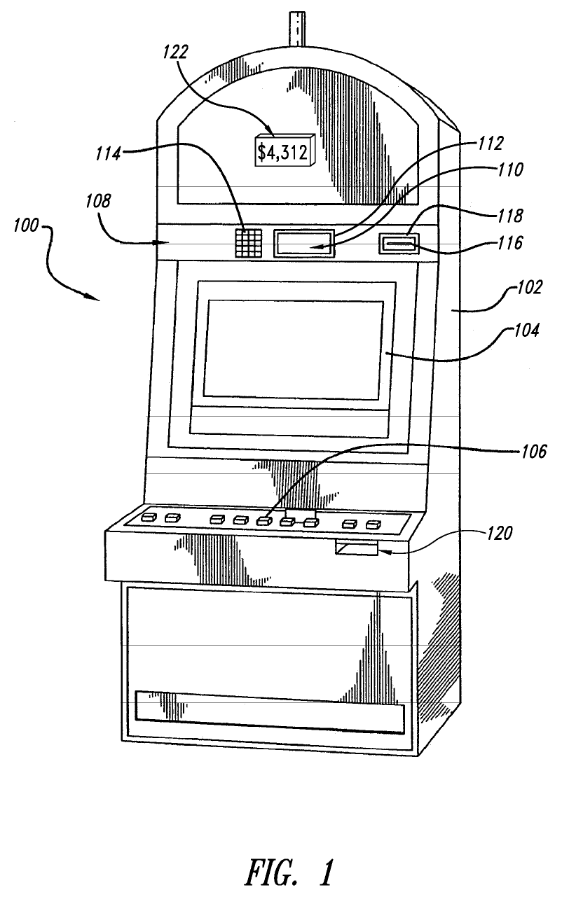

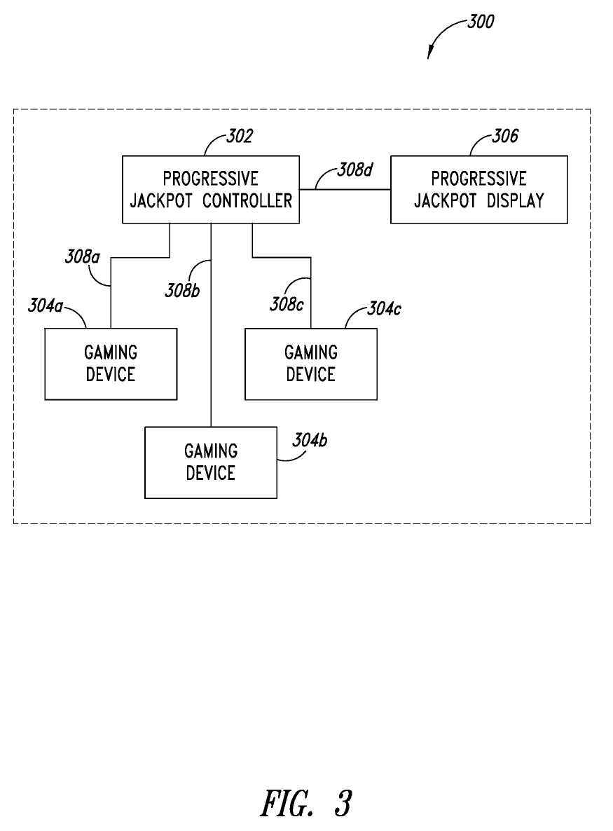

FIG. 1 shows a gaming device 100 configured to enable participation in at least two progressive jackpots. In one embodiment, the at least two progressive jackpots are individual progressive jackpots associated solely with the gaming device 100. However, in other embodiments, the at least two progressive jackpots may be group progressive jackpots associated with and enabling participation by a plurality of gaming devices. One embodiment including such group progressive jackpots is described in greater detail below with reference to FIG. 3.

As used herein, the term “progressive jackpot” is a general term referring to any jackpot wherein the value of the jackpot increases as a fraction of at least some wagers accepted at participating gaming devices. A progressive jackpot may also include other sources of funds, but at least a fraction of associated wagers is allocated to and increases the value of the progressive jackpot.

The gaming device 100 may be located within a gaming property (not shown) comprising any of a variety of establishments housing one or more gaming devices used for gaming/gambling. In one embodiment, the gaming device 100 may be located within a casino. However, even convenience stores or gas stations housing the gaming device 100 may be considered a gaming property.

The gaming device 100 may comprise any of a variety of electronic devices offering games of chance, games of skill, or combinations thereof that a player may wager on. Such games may include mechanical or video slots, video keno, video poker, video blackjack, Class II bingo, lottery, craps, a mechanical or video representation of a wheel game, etc. One example game of chance is BLAZING 7's, sold by Bally Technologies, Inc. In one embodiment, the gaming device 100 is a single-offering gaming device, enabling play of only one game. However, in other embodiments, the gaming device 100 is relatively flexible, allowing a player to choose from among a number of games.

In the illustrated embodiment, the exterior of the gaming device 100 may be defined by a housing 102. The housing 102 may be a self-standing unit that is generally rectangular in shape. In other embodiments, the housing may comprise a slant-top, bar-top, or table-top style cabinet. Of course, housings of various sizes and shapes may be used in different embodiments of the gaming device 100.

The gaming device 100 may further include a game display 104, operable to present the one or more games of chance or skill described above. In one embodiment, the game display 104 includes a CRT or a panel display, such as, but not limited to, liquid crystal, plasma, electroluminescent, vacuum fluorescent, field emission, or any other type of panel display. The game display 104 may also include a touch screen or touch glass system. Thus, the game display 104 may be configured to display a variety of information to a player engaging the gaming device 100 and simultaneously act as a user interface.

The gaming device 100 may further include a variety of other user interfaces via which a player may interact with the gaming device 100. As illustrated, a plurality of player-activated buttons 106 may be provided on a shelf of the housing 102. In one embodiment, a player interaction system 108 may also be provided at the top of the housing 102. This player interaction system 108 may include a graphics display 110, a touch bezel 112, a keypad 114, a player club card reader 116, and a card reader bezel 118.

The graphics display 110 may display a variety of information to a player and may be configured similarly to the game display 104 described above. The touch bezel 112 associated with the graphics display 110 and the keypad 114 may comprise user interfaces via which a player may enter information into or otherwise interact with the gaming device 100, and more specifically with the player interaction system 108.

In one embodiment, the player club card reader 116 may be configured to read any of a variety of player club cards issued by a gaming property associated with the gaming device 100, gaming property employee cards, smart cards, and the like. Thus, the player club card reader 116 may enable a gaming property to monitor and track player and employee activity each time a player or employee inserts his or her card into the player club card reader 116.

The gaming device 100 may further include a voucher printer (not visible) that prints to and then dispenses vouchers via a voucher slot 120. The voucher printer may comprise any of a variety of printers configured to encode vouchers that may be redeemed by a player. Of course, in other embodiments, other mechanisms for paying out players may be provided, including a coin hopper, a bill dispenser, a device for electronic funds transfer, etc.

The gaming device 100 of FIG. 1 may further include a local progressive jackpot display 122. This local progressive jackpot display 122 may comprise any of a variety of electronic displays and may be operable to display a current value of at least one of the progressive jackpots in which a player is participating. As the gaming device 100 enables participation in at least two progressive jackpots, the local progressive jackpot display 122 may be operable to display the current values of different progressive jackpots and to update those values to remain current. Of course, in other embodiments, the separate display 122 may be omitted. Instead, for example, a current value of a progressive jackpot may be displayed on the game display 104 or graphics display 110.

During operation, a player may purchase credits on the gaming device 100 in order to play the offered games using any of a variety of payment options (e.g., bills, coins, credit cards, player accounts at the gaming property 100, etc.). Although not illustrated, the gaming device 100 may, for example, include a bill acceptor, a credit/debit card acceptor, a coin slot, etc. In another embodiment, the gaming device 100 may enable a player to transfer money from a player's account to the gaming device 100 based at least in part on information read from a player club card.

For each game play (e.g., a virtual spin of a wheel game), the player may place a wager at the gaming device 100 corresponding to one or more bets having a certain bet denomination. Upon acceptance of the wager, the wagered amount may be subtracted from the credits associated with the player on the gaming device 100. Depending upon the outcome of the game, the player may then win additional credits or may lose the amount of the wager. For example, if the gaming device 100 offers video slots and accepts bets having a $0.25 bet denomination, a player may wager $1 on each spin by selecting four “bet lines” using the player-activated buttons 106 and placing a single bet on each bet line.

The gaming device 100 may be operable to accept wagers associated with a plurality of bet denominations. In one embodiment, a range of potential bet denominations may be displayed on the game display 104, and a player may select among them via one of the user interfaces of the gaming device 100. For example, a player may select among icons representative of $0.01, $0.05, $0.10, $0.25, $0.50, $1, or other bet denominations by touching the screen of the game display 104 and may then place a wager associated with the selected bet denomination. In other embodiments, a player may be able to enter any bet denomination up to a certain maximum bet. Thus, if a player wishes to place wagers in $0.47 increments, she may be permitted to select such a bet denomination.

In another embodiment, the bet denomination or at least the range of bet denominations available to players may be set by an employee of a gaming property via a server communicatively coupled to the gaming device 100. For example, the employee may choose to raise or lower the bet denomination at the gaming device 100 in order to encourage an optimal amount of game play to obtain increased revenues.

In yet another embodiment, the bet denomination or at least the range of bet denominations available to players may be determined automatically by the gaming device 100 itself or by a server communicatively coupled to the gaming device 100. This automatic determination may be accomplished in accordance with a variety of algorithms. In one embodiment, the bet denomination may be calibrated to obtain increased revenues. For example, the gaming device 100 may increase the bet denomination during peak gaming times (i.e., when demand is high) and decrease the bet denomination during off-hours (i.e., when demand is low).

It may be understood that the total amount of a wager is dependent upon but is not necessarily determined by the associated bet denomination. For example, many games allow players to place wagers corresponding to a plurality of bets having the associated bet denomination. Thus, a first player may place a single wager of five $0.10 bets, yielding a total amount wagered of $0.50, while a second player may place a wager of one $0.50 bet, similarly yielding a total amount wagered of $0.50. Different bet denominations may be associated with identical amounts wagered.

As indicated above, the gaming device 100 may enable participation in at least two progressive jackpots. That is, the gaming device 100 may enable participation in at least a first progressive jackpot and a second progressive jackpot, wherein the two distinct progressive jackpots are associated with respective bet denominations. Therefore, when a player places wagers associated with a first bet denomination, such wagers may be logically associated with the first progressive jackpot and not the second progressive jackpot, and the player may be eligible to win at least a portion of the first progressive jackpot. When the same player places wagers associated with a second bet denomination, such wagers may be logically associated with the second progressive jackpot and not the first progressive jackpot, and the player may be eligible to win at least a portion of the second progressive jackpot. In one embodiment, the gaming device 100 may enable participation in a different progressive jackpot for each available bet denomination.

The gaming device 100 may enable participation in a variety of progressive jackpots associated with different sets of participating gaming devices. In one embodiment, the gaming device 100 may host a first individual progressive jackpot and a second individual progressive jackpot. The first individual progressive jackpot may correspond to a bet denomination of $0.01, and the second individual progressive jackpot may correspond to a bet denomination of $0.05. In another embodiment, the gaming device 100 may enable participation in a first group progressive jackpot and a second group progressive jackpot. These group progressive jackpots may allow participation by a plurality of gaming devices, and they may also be associated with different bet denominations. For example, the first group progressive jackpot may correspond to a bet denomination of $0.10, and the second group progressive jackpot may correspond to bet denominations between $0.25 and $1. It may be understood that the gaming device 100 may enable participation in a combination of individual and group progressive jackpots that are associated with a single bet denomination or a plurality (or range) of bet denominations.

The group progressive jackpots may also be associated with more or fewer gaming devices. In one embodiment, a plurality of gaming devices in a single gaming property may be networked together (directly or indirectly) and may contribute to a group progressive jackpot. Such group progressive jackpots may be organized as bank-wide progressive jackpots associated with a plurality of gaming devices forming a bank, or gaming property-wide progressive jackpots associated with gaming devices throughout the gaming property. In other embodiments, group progressive jackpots may comprise county-wide or state-wide progressive jackpots associated with gaming devices in different gaming properties located throughout a geographical area.

In one embodiment, at least a portion of a progressive jackpot may be won when a particular outcome results from a game offered at the gaming device 100. For example, certain outcomes of a video slot game may indicate a win of at least a portion of an appropriate progressive jackpot. In another embodiment, a progressive jackpot may be associated with a bonus game that may be triggered at the gaming device 100. In such an embodiment, a player must first play the bonus game, in order to potentially win a portion of the appropriate progressive jackpot. The odds of winning each progressive jackpot may be fixed or variable.

Eligibility to win all or a portion of a progressive jackpot may also be based on one or more factors. In one embodiment, a player must place a wager equal to or greater than a certain minimum number of bets in order to be eligible. In another embodiment, a player may be eligible to win more or less of a progressive jackpot depending on the number of bets wagered. In yet another embodiment, if a single progressive jackpot is associated with a range of bet denominations, a player may be eligible to win different percentages of the progressive jackpot depending upon the particular bet denomination selected by the player. In another embodiment, a player must have a player account established at a gaming property associated with the gaming device 100 in order to be eligible. In still another embodiment, a certain amount of game play may be required before a player is eligible.

In one embodiment, the gaming device 100 may allocate at least a fraction of each wager to increase a corresponding progressive jackpot. For example, 1% of each wager associated with a first bet denomination may be allocated to the first progressive jackpot. Alternatively, in order to achieve effectively the same result, 50% of every 50th wager (or bet) or 100% of every 100th wager (or bet) associated with the first bet denomination (and so on) may be allocated to increase the first progressive jackpot. In another embodiment, the gaming device 100 may allocate at least a fraction of only particular wagers to the corresponding progressive jackpot (e.g., only those wagers made while playing particular games, or only those wagers in which a maximum number of bets has been placed).

In one embodiment, the progressive jackpots may be completely independent, and different fractions of wagers may be allocated to increase the different progressive jackpots. For example, a larger fraction of wagers associated with smaller bet denominations may be allocated in order to yield larger progressive jackpots at these bet denominations.

It may be understood that such an allocation is independent of any particular accounting method used to increase the progressive jackpot by the appropriate amount. In one embodiment, the value of the progressive jackpot may simply be incremented electronically, while the monies represented by the wagers collected are placed in one or more accounts held by a gaming property.

A progressive jackpot program executed on the gaming device 100 may be configured to monitor and administer the progressive jackpots hosted on the gaming device 100. For example, the progressive jackpot program may maintain, inter alia, information indicative of which fraction of wagers should be allocated to each progressive jackpot, rules associated with each progressive jackpot, and a current value of each progressive jackpot. The progressive jackpot program may also maintain other information associated with the wagers made at the gaming device 100. For example, in one embodiment, the progressive jackpot program may store information indicative of the sizes of the wagers, the times at which the wagers were placed, player identifiers associated with the wagers, etc.

Upon receiving a wager, the gaming device 100 may first determine that the wager is associated with a first bet denomination, and then the progressive jackpot program may cause the wager to be logically associated with the first progressive jackpot. The progressive jackpot program may then access information associated with the first progressive jackpot, and, based upon that information, the progressive jackpot program may cause at least a fraction of the wager to be allocated to increase the first progressive jackpot. The progressive jackpot program may also cause the local progressive jackpot display 122 to display the current value of the first progressive jackpot.

In another embodiment, the progressive jackpots (whether individual or group progressive jackpots) may be monitored and administered at one or more progressive jackpot servers/controllers in a gaming property associated with the gaming device 100. These progressive jackpot servers/controllers may then communicate information associated with the progressive jackpots back to the gaming device 100 as necessary.

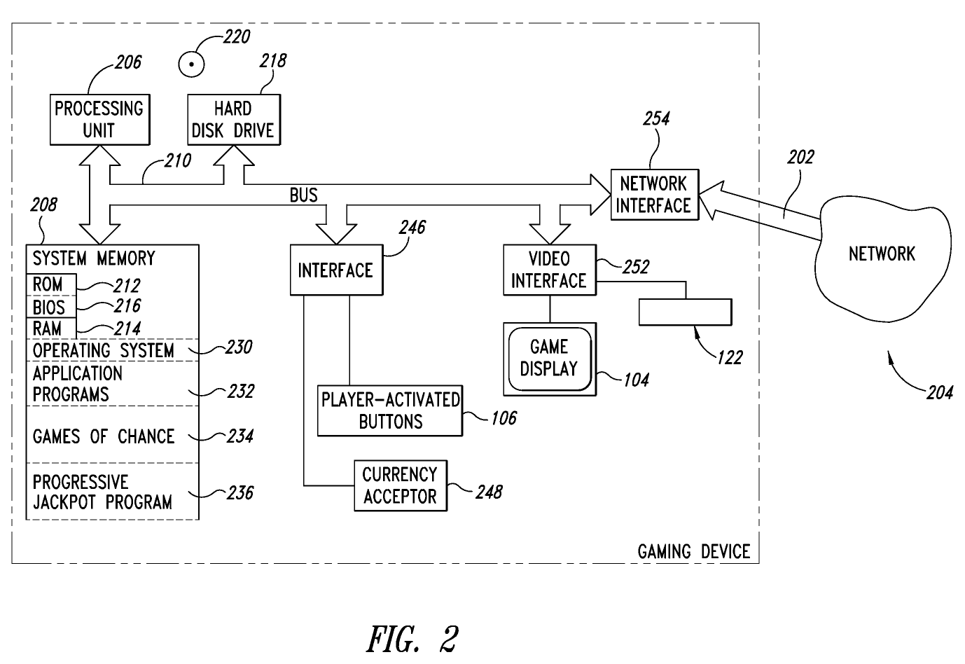

With reference to FIG. 2, the internal structure of the gaming device 100 may be described in greater detail. Although not required, the embodiments will be described in the general context of computer-executable instructions, such as program application modules, objects, or macros being executed by a computer. The embodiments can be practiced in distributed computing environments where tasks or modules are performed by remote processing devices, which are linked through a communications network. In a distributed computing environment, program modules may be located in both local and remote memory storage devices.

FIG. 2 is a schematic view of the gaming device 100. The gaming device 100 may be coupled by at least one communication channel/logical connection 202 to a network 204. Thus, in one embodiment, the gaming device 100 may be communicatively coupled with other gaming devices and/or with one or more servers or controllers within a gaming property.

The gaming device 100 may have an internal configuration similar to that of a conventional PC, which includes a processing unit 206, a system memory 208 and a system bus 210 that couples various system components including the system memory 208 to the processing unit 206. The gaming device 100 will at times be referred to in the singular herein, but this is not intended to limit the embodiments to a single processor. Non-limiting examples of commercially available computing systems include, but are not limited to, an 80×86 or Core series microprocessor from Intel Corporation, U.S.A., a PowerPC microprocessor from IBM, a Sparc microprocessor from Sun Microsystems, Inc., or a PA-RISC series microprocessor from Hewlett-Packard Company.

The processing unit 206 may be any logic processing unit, such as one or more central processing units (CPUs), digital signal processors (DSPs), application-specific integrated circuits (ASICs), field programmable gate arrays (FPGAs), etc. Unless described otherwise, the construction and operation of the various blocks shown in FIG. 2 are of conventional design. As a result, such blocks need not be described in further detail herein, as they will be understood by those skilled in the relevant art.

The system bus 210 can employ any known bus structures or architectures, including a memory bus with memory controller, a peripheral bus, and a local bus. The system memory 208 includes read-only memory (“ROM”) 212 and random access memory (“RAM”) 214. A basic input/output system (“BIOS”) 216, which can form part of the ROM 212, contains basic routines that help transfer information between elements within the gaming device 100, such as during start-up.

The gaming device 100 may also include a hard disk drive 218 for reading from and writing to a hard disk 220. The hard disk drive 218 may communicate with the processing unit 206 via the system bus 210. The hard disk drive 218 may also include an interface or controller (not shown) coupled between it and the system bus 210, as is known by those skilled in the relevant art. The hard disk drive 218 provides nonvolatile storage for computer-readable instructions, data structures, program modules and other data for the gaming device 100. Although the depicted gaming device 100 employs a hard disk 220, those skilled in the relevant art will appreciate that other types of computer-readable media that can store data accessible by a computer may be employed, such as magnetic cassettes, flash memory cards, Bernoulli cartridges, RAMs, ROMs, smart cards, optical disks, magnetic disks, etc.

Program modules can be stored in the system memory 208, such as an operating system 230, one or more application programs 232, one or more games of chance 234, and the progressive jackpot program 236. The system memory 208 may also include communications programs permitting the gaming device 100 to access and exchange data over a network. The progressive jackpot program 236, as described above, may enable the gaming device 100 to monitor and administer at least two progressive jackpots. In another embodiment, the progressive jackpot program 236 may serve as a client progressive jackpot program and may simply pass information indicative of wagers made at the gaming device 100 on to a progressive jackpot server or controller. The progressive jackpot server or controller may include its own server progressive jackpot program operable to logically associate wagers with appropriate progressive jackpots and perform associated tasks.

While shown in FIG. 2 as being stored in the system memory 208, the operating system 230, application programs 232, games 234 and progressive jackpot program 236 can be stored on the hard disk 220 of the hard disk drive 218.

A player can interact with the gaming device 100 through user interfaces such as the player-activated buttons 106. Other user interfaces for receiving user input can include a touch-sensitive display, the touch-sensitive bezel 112, joystick, game pad, tablet, etc. These and other user interfaces may be connected to the processing unit 206 through an interface 246 such as a universal serial bus (“USB”) interface that couples to the system bus 210, although other interfaces such as a parallel port, a game port or a wireless interface or a serial port may be used.

The interface 246 may further be coupled to a currency acceptor 248 configured to accept currency from a player. In one embodiment, the currency acceptor 248 may include one or more coin slots, bill acceptors, etc. In another embodiment, the gaming device 100 may include a card slot for receiving a financial card issued by a financial institution (e.g., a credit/debit card), via which credits may be purchased.

The game display 104 and other display devices may be coupled to the system bus 210 via a video interface 252, such as a video adapter. In one embodiment, the local progressive jackpot display 122 may also be coupled to the system bus 210 via the video interface 252, or via another video interface.

The gaming device 100 may operate in a networked environment using one or more logical connections 202 to communicate with one or more remote computers, servers and/or other gaming devices through the network 204. These logical connections may facilitate any known method of permitting computers to communicate, such as through one or more LANs and/or WANs, such as the Internet. Such networking environments are well known in wired and wireless enterprise-wide computer networks, intranets, extranets, and the Internet.

In one embodiment, the network interface 254 (communicatively linked to the system bus 210) may be used for establishing communications over the logical connection 202. In a networked environment, program modules, application programs, games, progressive jackpot programs, or portions thereof, can be stored outside of the gaming device 100 (not shown). Those skilled in the relevant art will recognize that the network connections shown in FIG. 2 are only some examples of ways of establishing communications between computing devices, and other connections may be used.

### Description of an Exemplary Gaming Property

FIG. 3 shows a gaming property 300 including a progressive jackpot controller 302 communicatively coupled to a plurality of gaming devices 304a-c (collectively 304) and to a global progressive jackpot display 306. Although only three gaming devices 304 are illustrated in FIG. 3, it may be understood that more or fewer gaming devices may be included in different embodiments.

As described above, the gaming property 300 may comprise any of a variety of establishments housing a plurality of gaming devices 304 used for gaming/gambling. In one embodiment, the gaming property 300 may be a casino.

Each of the gaming devices 304 may be configured generally similarly to the gaming device 100 described in detail with respect to FIGS. 1 and 2. In particular, each gaming device 304 may enable participation in a plurality of progressive jackpots and may accept wagers associated with a plurality of bet denominations. However, the gaming devices 304 of FIG. 3 may be operable to enable participation in at least two group progressive jackpots administered by the progressive jackpot controller 302, in which all three of the gaming devices 304 can participate.

A network may be formed within the gaming property 300 among the gaming devices 304 and the progressive jackpot controller 302. A plurality of logical connections 308a-d is illustrated between these computing devices. This gaming network may comprise any of a variety of networks and related hardware and/or software. The network may comprise a wired or wireless enterprise-wide computer network, intranet, extranet or the Internet. Other embodiments may be implemented in other types of communication networks.

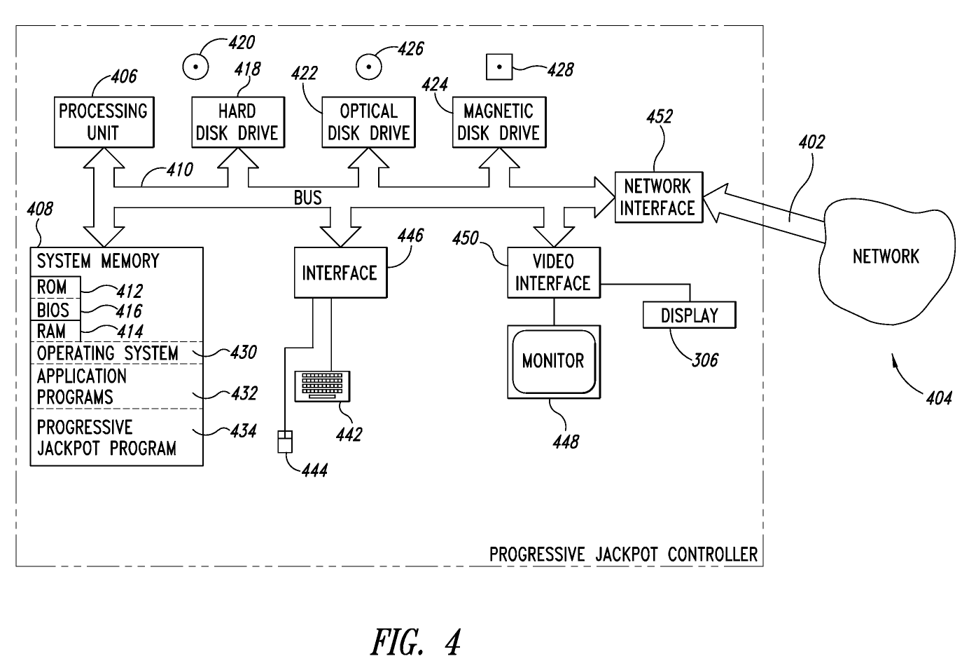

In one embodiment, the progressive jackpot controller 302 comprises a computing device communicatively coupled to the gaming devices 304. The progressive jackpot controller 302 may monitor and administer at least two group progressive jackpots in which the gaming devices 304 may participate. In one embodiment, the progressive jackpot controller 302 may perform many of the same tasks described above with reference to the progressive jackpot program 236. The progressive jackpot controller 302 may be implemented in any of a variety of types of hardware. One example progressive jackpot controller 302 is described in greater detail below with reference to FIG. 4.

Each of the gaming devices 304 may be operable to accept wagers associated with a plurality of bet denominations, and the bet denomination selected at any one gaming device 304 may be independent of the bet denominations selected at the other gaming devices 304. When a wager is made at a gaming device 304, information indicative of that wager may be forwarded to the progressive jackpot controller 302. The forwarded information may include, inter alia, information indicative of a bet denomination associated with the wager, a total wagered amount, as well as eligibility information. In another embodiment, the gaming devices 304 may have access to information indicative of the progressive jackpots. In such an embodiment, the gaming devices 304 may forward to the progressive jackpot controller 302 information indicative of a progressive jackpot with which a wager should be associated and information indicative of an amount by which that progressive jackpot should be increased.

The progressive jackpot controller 302 may receive this forwarded information and then determine the bet denomination associated with a wager based on the forwarded information. The progressive jackpot controller 302 may then logically associate the wager with a corresponding progressive jackpot. The progressive jackpot controller 302 may then increase the corresponding progressive jackpot by at least a fraction of the wager and may assist the gaming device 304 in determining whether or not a player has won at least a portion of the progressive jackpot.

The global progressive jackpot display 306 may be communicatively coupled to the progressive jackpot controller 302 and may be configured to display information associated with the progressive jackpots administered by the progressive jackpot controller 302. In one embodiment, the progressive jackpot controller 302 may cause the current values associated with each progressive jackpot to display on the global progressive jackpot display 306. Such values may be displayed adjacent a bet denomination or range of bet denominations associated with that progressive jackpot.

In one embodiment, the global progressive jackpot display 306 may comprise a computing device coupled to a large display viewable by players engaging the gaming devices 304. Information sent from the progressive jackpot controller 302 may be processed by the progressive jackpot display 306 and then displayed. In another embodiment, the progressive jackpot display 306 may simply comprise a display coupled directly to a video output of the progressive jackpot controller 302 or another computing device within the gaming property 300.

In another embodiment, information associated with the group progressive jackpots administered by the progressive jackpot controller 302 may be displayed on the gaming devices 304 themselves. For example, if a gaming device 304 is accepting wagers associated with a particular bet denomination, a current value of a progressive jackpot associated with that bet denomination may be displayed on a game display or a local progressive jackpot display of the gaming device 304. In one embodiment, as the bet denomination at a particular gaming device 304 is changed, the progressive jackpot information displayed on the gaming device 304 may also change in accordance with communications received from the progressive jackpot controller 302.

Of course, in other embodiments, there need not be a progressive jackpot controller 302 at all. For example, the gaming devices 304 may administer the group progressive jackpots themselves in a distributed or peer-to-peer architecture.

### Description of a Suitable Progressive Jackpot Controller

FIG. 4 and the following discussion provide a brief, general description of a suitable progressive jackpot controller 302 for use in the gaming property 300. Although not required, the embodiments will be described in the general context of computer-executable instructions, such as program application modules, objects, or macros being executed by a computer. Those skilled in the relevant art will appreciate that the illustrated embodiments as well as other embodiments can be practiced with other computer system configurations, including handheld devices, multiprocessor systems, microprocessor-based or programmable consumer electronics, personal computers (“PCs”), network PCs, minicomputers, mainframe computers, and the like. The embodiments can be practiced in distributed computing environments where tasks or modules are performed by remote processing devices, which are linked through a communications network. In a distributed computing environment, program modules may be located in both local and remote memory storage devices.

FIG. 4 shows the progressive jackpot controller 302 coupled by at least one communication channel/logical connection 402 to a network 404. This logical connection 402 may serve as any one of the logical connections 308 illustrated in FIG. 3 communicatively coupling the progressive jackpot controller 302 to the gaming devices 304.

The progressive jackpot controller 302 may take the form of a conventional PC, which includes a processing unit 406, a system memory 408 and a system bus 410 that couples various system components including the system memory 408 to the processing unit 406. The progressive jackpot controller 302 will at times be referred to in the singular herein, but this is not intended to limit the embodiments to a single computing device, since in certain embodiments, there will be more than one server or other networked computing device involved. Non-limiting examples of commercially available systems include, but are not limited to, an 80×86 or Pentium series microprocessor from Intel Corporation, U.S.A., a PowerPC microprocessor from IBM, a Sparc microprocessor from Sun Microsystems, Inc., or a PA-RISC series microprocessor from Hewlett-Packard Company.

The processing unit 406 may be any logic processing unit, such as one or more central processing units (CPUs), digital signal processors (DSPs), application-specific integrated circuits (ASICs), field programmable gate arrays (FPGAs), etc. Unless described otherwise, the construction and operation of the various blocks shown in FIG. 4 are of conventional design. As a result, such blocks need not be described in further detail herein, as they will be understood by those skilled in the relevant art.

The system bus 410 can employ any known bus structures or architectures, including a memory bus with memory controller, a peripheral bus, and a local bus. The system memory 408 includes read-only memory (“ROM”) 412 and random access memory (“RAM”) 414. A basic input/output system (“BIOS”) 416, which can form part of the ROM 412, contains basic routines that help transfer information between elements within the progressive jackpot controller 302, such as during start-up.

The progressive jackpot controller 302 may also include a hard disk drive 418 for reading from and writing to a hard disk 420, and an optical disk drive 422 and a magnetic disk drive 424 for reading from and writing to removable optical disks 426 and magnetic disks 428, respectively. The optical disk 426 can be a CD or a DVD, while the magnetic disk 428 can be a magnetic floppy disk or diskette. The hard disk drive 418, optical disk drive 422 and magnetic disk drive 424 communicate with the processing unit 406 via the system bus 410. The hard disk drive 418, optical disk drive 422 and magnetic disk drive 424 may include interfaces or controllers (not shown) coupled between such drives and the system bus 410, as is known by those skilled in the relevant art. The drives 418, 422, 424, and their associated computer-readable media 420, 426, 428, provide nonvolatile storage of computer-readable instructions, data structures, program modules and other data for the progressive jackpot controller 302. Although the depicted progressive jackpot controller 302 employs hard disk 420, optical disk 426 and magnetic disk 428, those skilled in the relevant art will appreciate that other types of computer-readable media that can store data accessible by a computer may be employed, such as magnetic cassettes, flash memory cards, Bernoulli cartridges, RAMs, ROMs, smart cards, etc.

Program modules can be stored in the system memory 408, such as an operating system 430, one or more application programs 432, and a server progressive jackpot program 434. The system memory 408 may also include communications programs for permitting communications over a network. As described above, the server progressive jackpot program 434 may enable the progressive jackpot controller 302 to monitor and administer at least two progressive jackpots.

While shown in FIG. 4 as being stored in the system memory 408, the operating system 430, application programs 432, and server progressive jackpot program 434 can be stored on the hard disk 420 of the hard disk drive 418, the optical disk 426 of the optical disk drive 422 and/or the magnetic disk 428 of the magnetic disk drive 424.

A user can enter commands and information into the progressive jackpot controller 302 through input devices such as a touch screen or keyboard 442 and/or a pointing device such as a mouse 444. Other input devices can include a microphone, joystick, game pad, tablet, scanner, etc. These and other input devices may be connected to the processing unit 406 through an interface 446 such as a universal serial bus (“USB”) interface that couples to the system bus 410, although other interfaces such as a parallel port, a game port or a wireless interface or a serial port may be used.

A monitor 448 and other display devices may be coupled to the system bus 410 via a video interface 450, such as a video adapter. In one embodiment, as illustrated, the global progressive jackpot display 306 may be coupled to the system bus 410 via the video interface 450.

The progressive jackpot controller 302 operates in a networked environment using one or more logical connections 402 to communicate with one or more remote gaming devices, servers and/or other computing devices through the network 404. These logical connections may facilitate any known method of permitting computers to communicate, such as through one or more LANs and/or WANs, such as the Internet. Such networking environments are well known in wired and wireless enterprise-wide computer networks, intranets, extranets, and the Internet. Other embodiments include other types of communication networks.

In one embodiment, a network interface 452 (communicatively linked to the system bus 410), may be used for establishing communications over the logical connection 402. In a networked environment, program modules, application programs, or portions thereof, can be stored outside of the progressive jackpot controller 302 (not shown). Those skilled in the relevant art will recognize that the network connections shown in FIG. 4 are only some examples of ways of establishing communications between computers, and other connections may be used.

### Description of an Exemplary Method for Enabling Participation in Progressive Jackpots

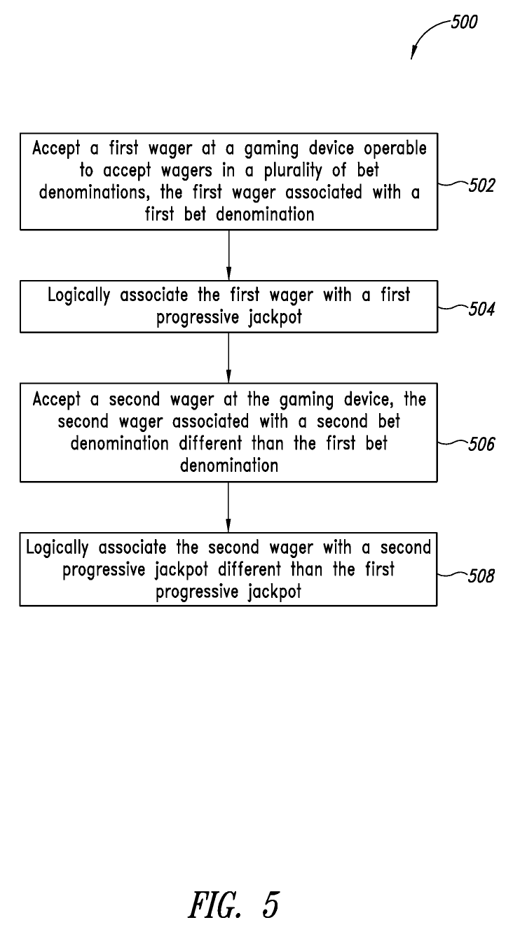

FIG. 5 illustrates a flow diagram for a method 500 of enabling participation in progressive jackpots, according to one embodiment. This method 500 will be discussed in the context of the gaming device 100 of FIGS. 1 and 2. However, it may be understood that the acts disclosed herein may be executed in a variety of different gaming devices and may involve multiple gaming devices, in accordance with the described method.

The method begins at 502, when a first wager is accepted at a gaming device 100 operable to accept wagers in a plurality of bet denominations, the first wager associated with a first bet denomination. The first wager may be accepted at the gaming device 100 in a variety of ways. In one embodiment, a player may first purchase a number of credits on the gaming device 100. For example, the player may use one or more currency acceptors (e.g., a coin slot, or bill acceptor) or a financial card reader. The player may then provide user input via a user interface of the gaming device 100 indicating a desire to place the first wager. Provided the wager meets certain criteria (e.g., the amount of the first wager is not greater than the purchased credits), the gaming device 100 may then accept the first wager. The amount of the first wager may then be subtracted from the purchased credits.

In one embodiment, the first wager is associated with the first bet denomination. That is, the first wager may comprise one or more bets having the first bet denomination. In one embodiment, the first bet denomination may be selected by a player interacting with the gaming device 100. For example, the gaming device 100 may accept user input via a user interface indicative of the first bet denomination. In another embodiment, the first bet denomination may be selected by a gaming property employee based upon any of a variety of factors. In yet another embodiment, the first bet denomination may be selected by a server or by the gaming device 100 automatically. Once selected, the first bet denomination may be displayed on the game display 104 or local progressive jackpot display 122 of the gaming device 100.

At 504, the first wager is logically associated with a first progressive jackpot. In one embodiment, the first wager may be logically associated with the first progressive jackpot based at least in part on the first bet denomination. That is, the first progressive jackpot may be associated with at least the first bet denomination and may even be associated with more than one bet denomination. Thus, since the first wager is associated with the first bet denomination, the first wager may, in turn, be logically associated with the first progressive jackpot.

This logical association may be performed at any of a number of computing devices within or outside a gaming property. In one embodiment, information indicative of the first progressive jackpot may be stored on the gaming device 100. Once the first wager is accepted at the gaming device 100, the gaming device 100 may logically associate the first wager with the first progressive jackpot. In another embodiment, information indicative of a plurality of progressive jackpots may be stored on a progressive jackpot controller (e.g., progressive jackpot controller 302) communicatively coupled to the gaming device 100. After the first wager is accepted at the gaming device 100, information indicative of the first wager may be sent from the gaming device 100 to the progressive jackpot controller, and the first wager may be logically associated with the first progressive jackpot.

A number of actions may be taken based at least in part on the above logical association. In one embodiment, at least a fraction of the first wager may be allocated to increase the first progressive jackpot. This allocation may occur at the gaming device 100 or at another computing device communicatively coupled to the gaming device 100. For example, the gaming device 100 may have stored thereon a table including an increment rate indicative of which fraction of the first wager should be allocated to the first progressive jackpot. In one embodiment, the gaming device 100 may determine the fraction of the first wager that should be allocated to the first progressive jackpot, and information indicative of this amount may be sent to another computing device administering the first progressive jackpot.

In another embodiment, the fraction allocated to the first progressive jackpot may be variable. When the first progressive jackpot is small, for example, the fraction may be larger to increase the value of the first progressive jackpot more quickly. However, once the first progressive jackpot has reached a certain value, the fraction may be reduced or eliminated.

Information indicative of the first progressive jackpot may also be displayed on the gaming device 100 while accepting the first wager. For example, a current value of the first progressive jackpot may be displayed on the local progressive jackpot display 122 within view of the player of the gaming device 100. Alternatively, information indicative of the first progressive jackpot may be displayed on a global progressive jackpot display visible to players at a plurality of gaming devices within a gaming property.

At 506, a second wager is accepted at the gaming device 100, the second wager associated with a second bet denomination different than the first bet denomination. As described above, the second wager may be accepted at the gaming device 100 in a variety of ways and may comprise one or more bets having the second bet denomination. In one embodiment, the second bet denomination may be displayed on the game display 104 or local progressive jackpot display 122 of the gaming device 100.

At 508, the second wager is logically associated with a second progressive jackpot different than the first progressive jackpot. Much of the above description pertaining to act 504 may be applied equally to act 508 as well, although with reference to the second progressive jackpot and not the first.

In one embodiment, based at least in part on this logical association, information indicative of the second progressive jackpot may be displayed on the gaming device 100 while accepting the second wager. Thus, in one embodiment, the local progressive jackpot display 122 may be changed upon accepting the second wager in order to display a current value of the second progressive jackpot.

Description of another Exemplary Method for Enabling Participation in Progressive Jackpots

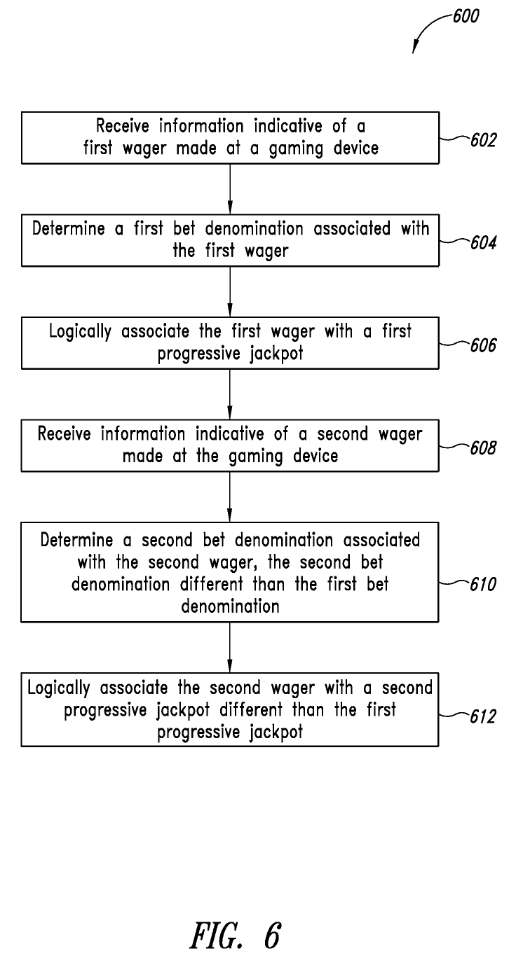

FIG. 6 illustrates a flow diagram for another method 600 of enabling participation in progressive jackpots, according to one embodiment. This method 600 will be discussed in the context of the gaming property 300 of FIG. 3. However, it may be understood that the acts disclosed herein may be executed in a variety of different gaming properties and may even involve multiple gaming properties, in accordance with the described method.

The method begins at 602, when information indicative of a first wager made at a gaming device 304 is received. The first wager may be placed at the gaming device as described above with respect to act 502. The gaming device 304 may be operable to accept wagers in a plurality of bet denominations, and the first wager may be associated with a first bet denomination.

The information indicative of the first wager may be received at a number of computing devices within the gaming property 300. In one embodiment, as described above with respect to method 500, the information may be received at the gaming device 304 itself. In another embodiment, information indicative of the first wager may be generated at the gaming device 304 and then forwarded on to another computing device, such as the progressive jackpot controller 302. This forwarded information may include, inter alia, information indicative of the first bet denomination associated with the first wager, a total amount of the first wager, as well as eligibility information. In another embodiment, the forwarded information may include information indicative of a first progressive jackpot associated with the first bet denomination, and information indicative of an amount by which the first progressive jackpot should be increased.

At 604, the first bet denomination associated with the first wager is determined. In one embodiment, the first bet denomination may be determined at the gaming device 304, and then information indicative of the first bet denomination may be forwarded on to the progressive jackpot controller 302 (which may then determine the first bet denomination itself based on the forwarded information). Alternatively, the gaming device 304 may send other information related to the first wager on to the progressive jackpot controller 302, which may determine the first bet denomination based at least in part on the information received.

At 606, the first wager is logically associated with a first progressive jackpot. In one embodiment, the first wager may be logically associated with the first progressive jackpot based at least in part on the determination of the first bet denomination. This logical association may be performed at any of a number of computing devices within or outside the gaming property 300. In one embodiment, characteristics and settings of the first progressive jackpot may be stored on the progressive jackpot controller 302. Then, as information indicative of the first wager is received at the progressive jackpot controller 302, the progressive jackpot controller 302 may logically associate this first wager with the first progressive jackpot. In another embodiment, the logical association may be performed at the gaming devices 304 themselves.

A number of actions may be taken based at least in part on the above logical association. In one embodiment, at least a fraction of the first wager may be allocated to increase the first progressive jackpot. The progressive jackpot controller 302 may itself determine the amount by which the first progressive jackpot should be increased, or the gaming device 304 may send the amount to the progressive jackpot controller 302.

In one embodiment, information indicative of the first progressive jackpot (e.g., the current value) may also be displayed on the global progressive jackpot display 306 visible to the players at the gaming devices 304. Of course, in other embodiments, local displays at the gaming devices 304 may instead display the current amount of the first progressive jackpot.

At 608, information indicative of a second wager made at the gaming device 304 is received. At 610, a second bet denomination associated with the second wager is determined, the second bet denomination different than the first bet denomination. Finally, at 612, the second wager is logically associated with a second progressive jackpot different than the first progressive jackpot. Much of the above description pertaining to acts 602, 604 and 606 may be applied equally to acts 608, 610 and 612 as well, although with reference to the second bet denomination and the second progressive jackpot.

In one embodiment, as illustrated in FIG. 3, a plurality of wagers may be accepted at the gaming devices 304. Information indicative of those wagers may be received at the progressive jackpot controller 302. At least a first of the plurality of wagers may be associated with the first bet denomination, and at least a second of the plurality of wagers may be associated with the second bet denomination. Upon receipt of the information indicative of the accepted wagers, the first of the plurality of wagers accepted at a first gaming device 304a may be logically associated with the first progressive jackpot, and the second of the plurality of wagers accepted at a second gaming device 304b may be logically associated with the second progressive jackpot.

In one embodiment, while accepting these wagers, a current value of the first progressive jackpot and a current value of the second progressive jackpot may be displayed. These values may be displayed on a number of displays within the gaming property 300. In one embodiment, the current value of the first progressive jackpot may be displayed on a local display of the first gaming device 304a, and the current value of the second progressive jackpot may be displayed on a local display of the second gaming device 304b. In another embodiment, the current values of the first progressive jackpot and the second progressive jackpot may be displayed on the global progressive jackpot display 306 within view of all of the plurality of gaming devices 304. In such an embodiment, each player may view the global progressive jackpot display 306 to determine a current value of the progressive jackpot associated with the wagers they are making.

At least a first fraction of each of the plurality of wagers associated with the first bet denomination may be allocated to increase the first progressive jackpot, and at least a second fraction of each of the plurality of wagers associated with the second bet denomination may be allocated to increase the second progressive jackpot. In one embodiment, the progressive jackpot controller 302 may itself determine the amount to allocate to increase the first and second progressive jackpots. In another embodiment, the gaming devices 304 accepting the wagers may determine the fractions of the wagers that should be allocated to the corresponding progressive jackpots, and information indicative of these amounts may be sent to the progressive jackpot controller 302.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more programs executed by one or more processors, as one or more programs executed by one or more controllers (e.g., microcontrollers), as firmware, or as virtually any combination thereof, and that designing the circuitry and/or writing the code for the software and or firmware would be well within the skill of one of ordinary skill in the art in light of this disclosure.

When logic is implemented as software and stored in memory, one skilled in the art will appreciate that logic or information can be stored on any computer readable medium for use by or in connection with any processor-related system or method. In the context of this document, a memory is a computer-readable medium that is an electronic, magnetic, optical, or other physical device or means that contains or stores a computer and/or processor program. Logic and/or the information can be embodied in any computer-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “computer-readable medium” can be any means that can store the program associated with logic and/or information for use by or in connection with the instruction execution system, apparatus, and/or device. The computer-readable medium can be, for example, but is not limited to, an electronic, magnetic, optical, electromagnetic, infrared, or semiconductor system, apparatus or device. More specific examples (a nonexhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), and a portable compact disc read-only memory (CDROM). Note that the computer-readable medium could even be paper or another suitable medium upon which the program associated with logic and/or information is printed, as the program can be electronically captured, via for instance optical scanning of the paper or other medium, then compiled, interpreted or otherwise processed in a suitable manner if necessary, and then stored in memory.

The various embodiments described above can be combined to provide further embodiments. From the foregoing it will be appreciated that, although specific embodiments have been described herein for purposes of illustration, various modifications may be made without deviating from the spirit and scope of the teachings. Accordingly, the claims are not limited by the disclosed embodiments.

We/I claim:

1. A computer-implemented method of enabling participation in progressive jackpots in a gaming property, the method comprising:
accepting a first wager at a gaming device operable to accept wagers in a plurality of bet denominations, the first wager associated with a first bet denomination;
logically associating the first wager with a first progressive jackpot;
accepting a second wager at the gaming device, the second wager associated with a second bet denomination different than the first bet denomination; and
logically associating the second wager with a second progressive jackpot different than the first progressive jackpot.

2. The method of claim 1, wherein logically associating the first wager with the first progressive jackpot includes allocating at least a first fraction of the first wager to increase the first progressive jackpot; and wherein logically associating the second wager with the second progressive jackpot includes allocating at least a second fraction of the second wager to increase the second progressive jackpot.

3. The method of claim 1, further comprising, while accepting the first wager at the gaming device, displaying a current value of the first progressive jackpot on a display within view of a player of the gaming device.

4. The method of claim 3, further comprising, while accepting the second wager at the gaming device, displaying a current value of the second progressive jackpot on the display.

5. The method of claim 1, further comprising:
accepting a plurality of wagers at a plurality of gaming devices operable to accept wagers in a plurality of bet denominations, at least a first of the plurality of wagers associated with the first bet denomination and at least a second of the plurality of wagers associated with the second bet denomination;
logically associating the first of the plurality of wagers accepted at a first of the plurality of gaming devices with the first progressive jackpot; and
logically associating the second of the plurality of wagers accepted at a second of the plurality of gaming devices with the second progressive jackpot.

6. The method of claim 5, further comprising displaying a current value of the first progressive jackpot and a current value of the second progressive jackpot.

7. The method of claim 6, wherein displaying the current value of the first progressive jackpot and the current value of the second progressive jackpot includes displaying the current value of the first progressive jackpot on a first display of the first of the plurality of gaming devices, and displaying the current value of the second progressive jackpot on a second display of the second of the plurality of gaming devices.

8. The method of claim 6, wherein displaying the current value of the first progressive jackpot and the current value of the second progressive jackpot includes displaying the current value of the first progressive jackpot and the current value of the second progressive jackpot on a global display visible to players of the plurality of gaming devices.

9. The method of claim 5, further comprising:
allocating at least a first fraction of each of the plurality of wagers associated with the first bet denomination to increase the first progressive jackpot; and
allocating at least a second fraction of each of the plurality of wagers associated with the second bet denomination to increase the second progressive jackpot.

10. The method of claim 1, wherein accepting the first wager includes accepting user input indicative of the first bet denomination via a user interface of the gaming device, and wherein accepting the second wager includes accepting user input indicative of the second bet denomination via the user interface.

11. A gaming device comprising:
a housing;
a display carried by the housing;
a user interface carried by the housing and configured to receive user input from a player;
a processor that executes instructions; and
a computer-readable memory that stores instructions that cause the processor to enable participation in progressive jackpots, by:
accepting a first wager associated with a first bet denomination via the user interface;
logically associating the first wager with a first progressive jackpot;
accepting a second wager associated with a second bet denomination different than the first bet denomination via the user interface; and
logically associating the second wager with a second progressive jackpot different than the first progressive jackpot.

12. The gaming device of claim 11, wherein logically associating the first wager with the first progressive jackpot includes allocating at least a first fraction of the first wager to increase the first progressive jackpot; and wherein logically associating the second wager with the second progressive jackpot includes allocating at least a second fraction of the second wager to increase the second progressive jackpot.

13. The gaming device of claim 11, wherein the computer-readable memory stores further instructions that cause the processor to enable participation in progressive jackpots by, while accepting the first wager, displaying a current value of the first progressive jackpot on the display.

14. The gaming device of claim 13, wherein the computer-readable memory stores further instructions that cause the processor to enable participation in progressive jackpots by, while accepting the second wager, displaying a current value of the second progressive jackpot on the display.

15. The gaming device of claim 11, wherein accepting the first wager associated with the first bet denomination includes accepting user input indicative of the first bet denomination via the user interface, and wherein accepting the second wager associated with the second bet denomination includes accepting user input indicative of the second bet denomination via the user interface.

16. The gaming device of claim 11, wherein the first progressive jackpot and the second progressive jackpot are associated with a plurality of gaming devices.

17. A computer-readable medium that stores instructions that cause a processor to enable participation in progressive jackpots, by:
receiving information indicative of a first wager made at a gaming device;
determining a first bet denomination associated with the first wager;
logically associating the first wager with a first progressive jackpot;
receiving information indicative of a second wager made at the gaming device;
determining a second bet denomination associated with the second wager, the second bet denomination different than the first bet denomination; and
logically associating the second wager with a second progressive jackpot different than the first progressive jackpot.

18. The computer-readable medium of claim 17, wherein logically associating the first wager with the first progressive jackpot includes allocating at least a first fraction of the first wager to increase the first progressive jackpot; and wherein logically associating the second wager with the second progressive jackpot includes allocating at least a second fraction of the second wager to increase the second progressive jackpot.

19. The computer-readable medium of claim 17, where the instructions cause the processor to enable participation in progressive jackpots further by:
while accepting the first wager at the gaming device, causing a current value of the first progressive jackpot to be displayed within view of a player of the gaming device.

20. The computer-readable medium of claim 19, where the instructions cause the processor to enable participation in progressive jackpots further by:
while accepting the second wager at the gaming device, causing a current value of the second progressive jackpot to be displayed within view of the player.

21. The computer-readable medium of claim 17, where the instructions cause the processor to enable participation in progressive jackpots further by:
receiving information indicative of a plurality of wagers made at a plurality of gaming devices;
determining that at least a first of the plurality of wagers is associated with the first bet denomination;
determining that at least a second of the plurality of wagers is associated with the second bet denomination;
logically associating the first of the plurality of wagers accepted at a first of the plurality of gaming devices with the first progressive jackpot; and
logically associating the second of the plurality of wagers accepted at a second of the plurality of gaming devices with the second progressive jackpot.

22. The computer-readable medium of claim 21, where the instructions cause the processor to enable participation in progressive jackpots further by:
causing a current value of the first progressive jackpot and a current value of the second progressive jackpot to be displayed.

23. The computer-readable medium of claim 22, wherein causing the current value of the first progressive jackpot and the current value of the second progressive jackpot to be displayed includes causing the current value of the first progressive jackpot and the current value of the second progressive jackpot to be displayed on a global display visible to players of the plurality of gaming devices.

24. The computer-readable medium of claim 21, where the instructions cause the processor to enable participation in progressive jackpots further by:
allocating at least a first fraction of each of the plurality of wagers associated with the first bet denomination to increase the first progressive jackpot; and
allocating at least a second fraction of each of the plurality of wagers associated with the second bet denomination to increase the second progressive jackpot.
